(19) United States
(12) Patent Application Publication
(10) Pub. No.: US 2009/0240522 A1
(43) Pub. Date: Sep. 24, 2009

(54) COMPUTER AIDED INTAKE AND ASSESSMENT SYSTEM

(75) Inventor: Nelson M. Handal, Dothan, AL (US)

Correspondence Address: DOVAS LAW P.C., 307 BAINBRIDGE STREET, PHILADELPHIA, PA, 19147, US

(73) Assignee: HARMONEX, INC., Dothan, AL (US)

(21) Appl. No.: 12/052,472

(22) Filed: Mar. 20, 2008

(51) Int. Cl. G06Q 50/00

(52) U.S. Cl. 705/2

(57) ABSTRACT

A patient intake and assessment system for communication with end users in a computer network is provided. The system includes a server configured to transmit instructions to a first client application to provide health assessment queries to a first end user and to receive health assessment query responses from the first end user. The server further transmits instructions to a second client application to provide the health assessment query responses of the first end user to a second end user and to provide to the second end user one or more health assessments based on the health assessment query responses. The server receives from the second end user selectively through the second client application acceptances of the health assessments, rejections of the health assessments, and user-generated health diagnoses. A client application program product for enabling patient intake and assessment is also provided.

### BACKGROUND

Health professionals face the increasingly difficult task of providing competent medical services at reasonable cost with an appropriate level of personal attention to each patient in their care. While the amount of potential diagnoses and treatment options are ever greater, the amount of time a health professional may spend with a patient is less, often limited by the strict reimbursement structure dictated by the health insurance industry. Such pressures may result in improper diagnoses or treatment and the associated increased risk of medical malpractice. Medical fields in which a high level of patient interaction is required to effect a diagnosis and provide medical treatment, such as the mental health field, are particularly strained and subject to unsettlingly high operating risks.

One of the most time intensive aspects of patient interaction is client intake, in which the patient discloses symptoms, background factors and health history to permit a health professional to make a proper assessment and offer treatment options. In the case of a psychiatric intake by a trained mental health professional, a proper initial intake and assessment will in most cases require 2-3 hours of a health professional's time. Mental health professionals in particular will typically ask an extensive battery of queries to arrive at a proper assessment, which in most cases will include one or more of the diagnoses listed in the Diagnostic and Statistical Manual of Mental Disorders (DSM) and/or International Statistical Classification of Diseases and Related Health Problems (ICD) with a corresponding identification code. Patients with a diagnosed mental health condition typically undergo long term treatment and require additional time-intensive follow-up intakes to assess improvement or deterioration of diagnosed conditions, and to make changes in background and health history information.

There are more than fifty commonly diagnosed mental health conditions, most of which share symptoms with one or more other ones of those mental health conditions. There is significant risk that a mental health professional may fail to present every appropriate query or fail to make record of every patient response necessary to effect a proper diagnosis. Also, the queries used to arrive at a particular mental health diagnosis may often be of a sensitive or personal nature or may require a high level of understanding of ones own feelings and reactions. Accordingly, a patient may purposely or inadvertently provide inaccurate information to a mental health professional during a psychiatric intake, hampering a fast and accurate assessment. The risk of a mental health professional failing to ask relevant and appropriate questions or receiving misinformation from a patient grows considerably during long term treatment of a patient. Accordingly, tracking a patient's progress, including the patient's reaction to prescribed mediations, is often difficult, and a mental health professional is often left to subjective factors for determining the efficacy of a course of treatment.

A health professional that is in fact successful in tracking a patient's progress and determining the efficacy of a particular course of treatment may ultimately be successful in treating the patient. However, the information gleaned from successes, or alternatively failures, typically inures only to the benefit of the treating health professional or the treating health professional's associates. Such data would be invaluable to other health professionals treating similar conditions or to researchers trying to determine the efficacy of a particular course of treatment.

It would be desirable to provide a patient intake and assessment system which permits efficient retrieval of patient information and provides a health professional with a proposed assessment of a patient. Such system should allow for a patient to answer questions at a pace and in an environment which is comfortable for the patient to encourage accurate and candid query responses. The system should allow for a health professional to review, change and selectively approve assessments. The system should permit the secure logging and storage of assessments including patient query responses for tracking a particular patient's progress, determining the efficacy of a course of treatment of a particular patient, and using data obtained during treatment of a particular patient to assess other patients.

### SUMMARY

The present invention provides a patient intake and assessment system for communication with end users in a computer network. The system includes a clinical algorithm database configured to store health assessment queries and health assessments. A clinician assessment report database is configured to store clinician assessment reports. A server is in communication with the clinical algorithm database and the clinician assessment report database. The server is configured to transmit instructions to a first client application to provide the health assessment queries to a first end user and to receive health assessment query responses from the first end user. The server transmits instructions to a second client application to provide the health assessment query responses to a second end user and to provide one or more of the health assessments based on the health assessment query responses to the second end user. The server receives from the second end user selectively through the second client application acceptances of the health assessments, rejections of the health assessments, and user-generated health diagnoses. The server generates a clinician assessment report including the health assessment query responses and the acceptances of the plurality of health assessments, the rejections of the health assessments, and the user-generated health diagnoses, and logs the clinician assessment report in the clinician assessment report database.

The present invention further provides a method for clinical patient intake and assessment. The method includes providing a server, and transmitting from the server health assessment queries to a first end user. The server receives health assessment query responses from the first end user and generates a health assessment based on the health assessment query responses from the first end user. The server transmits the health assessment to a second end user and receives selectively from the second end user an acceptance of the health assessment and a rejection of the health assessment. The server generates a clinician assessment report including the acceptance of the health assessment or the rejection of the health assessment. One or more of the health assessment queries are transmitted from the server to the first end user based on one or more of the health assessment query responses from the first end user.

The present invention further provides a client application program product having a computer readable medium with instructions operable to enable a client computer to perform a procedure. This procedure includes identifying a first end user and a second end user, and receiving instructions from a server to provide health assessment queries to the first end user. This procedure further includes transmitting health assessment query responses from the first end user to the server, and receiving instructions from the server to provide a health assessment to a second end user based on the health assessment query responses from the first end user. The instructions enable a client computer to transmit from the second end user to the server selectively an acceptance of the health assessment, a rejection of the health assessment, and a user-generated health diagnosis. The client computer is further enabled to receive instructions from the server to provide to the second end user a clinician assessment report including one or more of the acceptance of the health assessment, the rejection of the health assessment, and the user-generated health diagnosis.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a schematic illustration of an exemplary operating environment including a system for patient intake and assessment according to a preferred embodiment of the present invention.

FIG. 2 is a flow diagram showing a logic routine for generating a preliminary health assessment report according to a preferred embodiment of the present invention.

FIG. 3 is a flow diagram showing a clinician diagnosis procedure according to the preferred embodiment of the present invention.

FIG. 4 is a diagram of a method for patient intake and assessment according to the preferred embodiment of the present invention.

FIGS. 5A-5F show sample screen captures from displays of a patient user interface generated by a patient client application implementing the method for patient intake and assessment according to the preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

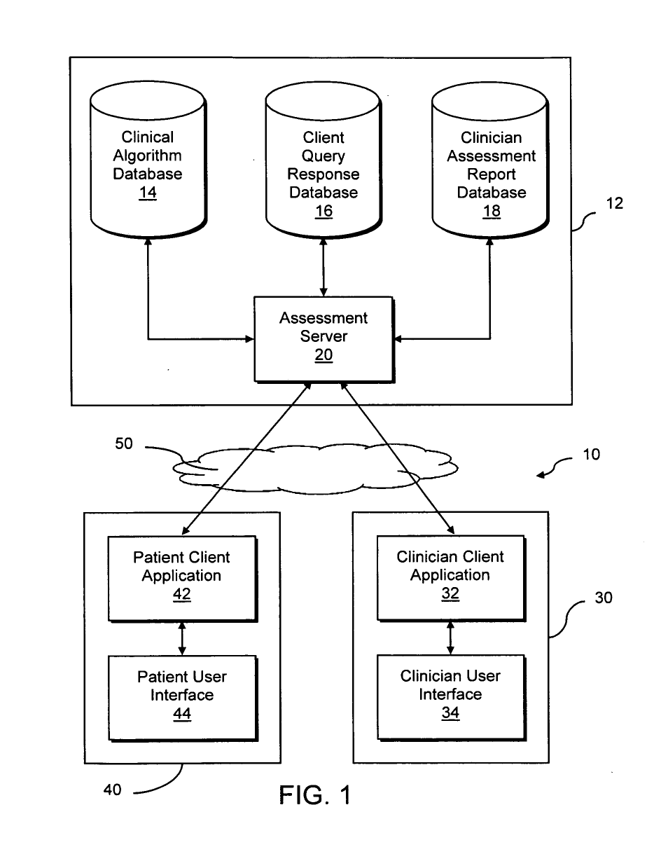

Referring to FIG. 1, a schematic illustration is shown of an exemplary operating environment 10 in which a patient intake and assessment system 12 according to a preferred embodiment of the present invention may be implemented for communication with end users in a computer network. The system 12 includes a clinical algorithm database 14 configured to store health assessment queries and health assessments corresponding to the health assessment queries. A client query response database 16 is configured for storing patient health assessment query responses. A clinician assessment report database 18 is configured to store clinician assessment reports. An assessment server 20 is provided in communication with the clinical algorithm database 14, client query response database 16, and the clinician assessment report database 18 for communication with end users through a network. The network may include the Internet 50 as shown, or alternatively, any suitable WAN or LAN. The assessment server 20 may be provided as a single server, or alternatively, as a plurality of cooperating connected servers. Further, the clinical algorithm database 14, client query response database 16, and the clinician assessment report database 18 may be provided as a single integrated database or any suitable number of separate databases.

The patient intake and assessment system 12 is preferably a mental health assessment system, and the clinical algorithm database 14 preferably stores mental health assessment queries and corresponding mental health assessments in the form of rules based algorithms. The mental health assessment queries include symptom queries which preferably implement criteria of the Diagnostic and Statistical Manual of Mental Disorders (DSM) to form the rules based algorithms, and more preferably implement a recent professionally accepted version thereof, for example the DSM-IV-TR or later revision. The mental health assessment queries may also implement other criteria not present in any version of the DSM in forming the rules based algorithms. The corresponding mental health assessments preferably include conditions set forth in the DSM and/or conditions set forth in a recent professionally accepted version of the International Statistical Classification of Diseases and Related Health Problems (ICD), for example the ICD-9-CM or later revision. DSM or ICD identification codes are preferably provided in the clinical algorithm database 14 corresponding with the respective conditions. Table 1 below sets forth a list of DSM conditions with corresponding DSM-IV-TR codes for which assessments may be provided by the system 12. Alternatively, the system 12 may provide health assessments for other conditions not listed below.

TABLE 1

| No. | Code | Condition |
|---|---|---|
| 1. | 308.30 | Acute Stress Disorder |
| 2. | 307.10 | Anorexia Nervosa |
| 3. | 300.00 | Anxiety Disorder NOS |
| 4. | 299.80 | Asperger's Disorder |
| 5. | 314.01 | Attention-Deficit Hyperactivity Disorder, Combined |
| | | Type |
| 6. | 314.01 | Attention-Deficit Hyperactivity Disorder, |
| | | Predominantly Hyperactive- |
| | | Impulsive Type |
| 7. | 314.00 | Attention-Deficit Hyperactivity Disorder, |
| | | Predominantly Inattentive Type |
| 8. | 314.90 | Attention-Deficit Hyperactivity Disorder NOS |
| 9. | 299.00 | Autistic Disorder |
| 10. | 296.60 | Bipolar I Disorder |
| 11. | 296.60 | Bipolar I Disorder, Mixed |
| 12. | 296.89 | Bipolar II Disorder |
| 13. | 298.80 | Brief Psychotic Disorder |
| 14. | 307.51 | Bulimia Nervosa |
| 15. | 307.90 | Communication Disorder |
| 16. | 301.14 | Cyclothymic Disorder |
| 17. | 294.80 | Dementia NOS |
| 18. | 311.00 | Depressive Disorder NOS |
| 19. | 312.09 | Disruptive Behavior Disorder NOS |
| 20. | 300.15 | Dissociative Disorder NOS |
| 21. | 300.40 | Dysthymic Disorder |
| 22. | 307.70 | Encopresis |
| 23. | 307.60 | Enuresis |
| 24. | 300.20 | Generalized Anxiety Disorder |
| 25. | 312.30 | Impulse Control Disorder |
| 26. | 315.90 | Learning Disorder NOS |
| 27. | 296.00 | Major Depressive Disorder |
| 28. | 296.00 | Manic Episode |
| 29. | 296.60 | Mixed Episode |
| 30. | 296.90 | Mood Disorder NOS |
| 31. | 300.30 | Obsessive Compulsive Disorder |
| 32. | 313.81 | Oppositional Defiant Disorder |
| 33. | 300.20 | Overanxious Disorder |
| 34. | 300.01 | Panic Disorder |
| 35. | 299.80 | Pervasive Developmental Disorder NOS |
| 36. | 307.52 | Pica |
| 37. | 309.81 | Posttraumatic Stress Disorder |
| 38. | 298.90 | Psychotic Disorder NOS |
| 39. | 313.89 | Reactive Attachment Disorder |
| 40. | 295.70 | Schizoaffective Disorder |
| 41. | 295.20 | Schizophrenia, Catatonic Type |
| 42. | 295.10 | Schizophrenia, Disorganized Type |
| 43. | 295.30 | Schizophrenia, Paranoid Type |
| 44. | 295.60 | Schizophrenia, Undifferentiated Type |
| 45. | 295.40 | Schizophreniform Disorder |
| 46. | 313.23 | Selective Mutism |
| 47. | 309.21 | Separation Anxiety Disorder |
| 48. | 307.40 | Sleep Disorders |
| 49. | 300.23 | Social Phobia |
| 50. | 300.29 | Specific Phobia |
| 51. | 307.00 | Stuttering |
| 52. | 305.90 | Substance Abuse |
| 53. | 304.90 | Substance Dependence |
| 54. | 307.22 | Tic Disorder, Chronic Motor or Vocal |
| 55. | 307.23 | Tourette's Disorder |

The assessment server 20 is configured to interact with a clinician client application 32 on a clinician client system 30 and a patient client application 42 on patient client system 40. The patient client application 42 is preferably accessible by a patient, and the clinician client application 32 is preferably accessible by a clinician who is a health services professional. The clinician client application 32 and the patient client application 42, may alternatively reside on a single system, and further, the clinician client application 32 and the patient client application 42 may be provided as a single application capable of providing alternate access to the assessment server 12 by a patient and a client. Both the clinician client application 32 and the patient client application 42 are preferably web browsers. Alternatively, the clinician client application 32 and the patient client application 42 may include any application or applications suitable for interaction with the assessment server 20 through a network such as the Internet 50 or other suitable WAN or LAN. Alternatively, the server 20 may be provided integrally with the clinician client system 30 and/or the patient client system 40, for example as a single standalone client intake and assessment system.

The clinician client application 32 and the patient client application 42 respectively interact with a clinician user interface 34 and a patient user interface 44, which include suitable video and/or audio devices and input devices to permit end user interaction. The systems 30, 40 each preferably comprise personal computers, and the interfaces 34,44 each preferably include a monitor and/or audio speakers, and a keyboard device and/or a microphone input to permit an end user to communicate with the respective systems 30, 40 in a manner suitable and convenient for the end user. Any type of personal computers can be provided including desktop computers, laptop computers, and tablet PCs. Even PDAs and other handheld devices may function effectively as clinician or patient client systems. Accordingly, the intake and assessment system 12 may potentially be accessed by end users through the Internet 50 or other suitable network from anywhere on earth, providing a high level of convenience for clinicians, patients, and others responsible for the care of patients such as parents and guardians. While only one clinician client application 32 and one patient client application 42 with respective systems are shown, one skilled in the art will recognize that any suitable number of client and patient applications with respective systems may be provided.

The assessment server 20 is configured to transmit instructions to the patient client application 42 to provide the health assessment queries to a patient end user using the patient client system 40. The queries may be provided in any manner understandable manner and may implement sound, video and voice. Preferably, a plurality of languages are available for selection by the user, and the assessment server 20 preferably includes Unicode support enabling multilingual use. An avatar in the form of an on-screen human or human-like character may be used to ask questions and respond to patient end user input to provide the patient end user with an increased level of comfort during an intake procedure.

The patient end user is preferably a patient with particular mental health needs and interacts with the patient client application 42 while under supervision of a health services professional. Alternatively, the patient end user may include one or more of a parent, guardian, teacher, care giver, social worker or other party responsible for the patient and legally authorized to access patient data. The patient client system 40 is preferably positioned at a location where health services are provided, such as a hospital, clinic or health service professional office location. Alternatively, the patient end user may interact with the patient client application 42 in any suitable environment where secure access is possible, including for example the patient's home or the home or office of a person responsible for the patient, in which case the personal computer of the patient or one responsible for the patient preferably functions as the patient client system 40, and a web browser on the system may function as the patient client application 42.

As indicated above, the health assessment queries preferably relate to mental health assessment and include symptom queries implementing DSM criteria. The mental health assessment queries preferably also include environmental stressor queries and risk factor queries as a well as health history queries. Where applicable, the symptom queries provide a scaled response selection so a patient end user may offer an indication of to what degree or intensity a symptom is present. Preferably the scaled response selection includes a numeric scale from 0 to 10, wherein 0 corresponds to an indication that no symptoms are present and 10 corresponds to an indication that severe symptoms are present. Where applicable, the symptom queries also provide a symptom duration selection so a patient end user may offer an indication of the duration of time a symptom has been present. Where applicable, the environmental stressor queries and the risk factor queries may also provide a scaled response selection and duration selection. The mental health assessment queries may further provide multiple choice, true-false-unknown, yes-no-unknown, free form text entry type queries or any suitable type queries. One skilled in the mental health profession would recognize that symptom queries relate to a patient's physical condition or mental outlook, while environmental stressor and risk factor queries relate to external factors not directly controlled by a patient.

The assessment server 20 is configured to receive health assessment query responses to the health assessment queries from a patient end user using the patient client system 40. As indicated above, the patient end user may include one or more other parties responsible for a patient. In such manner, the intake and assessment system 12 provides for the receiving of query responses from more than one party regarding the condition of a single patient, which assists in the verification and corroboration of the query responses. In view of the query types indicated above, the query responses may be in any suitable form including but not limed to a scaled type, duration type, multiple choice, true-false-unknown, yes-no-unknown, or free form text entry response. The client query response database 16 is configured for logging the health assessment query responses from the patient end user. The assessment server 20 is configured to transmit instructions to the patient client application 42 to provide following health assessment queries based on preceding health assessment query responses from the patient end user. In this manner the patient end user is offered health assessment queries most relevant to the patient end user's potential condition or the potential condition of the patient under the responsibility of the patient end user. Preferably, during initial stages of interface with the assessment server 20, the patient end user is provided a chief complaint query asking the client to choose from a plurality of chief complaints. Upon selection of one or more of the chief complaints, the assessment server 20 provides further health assessment queries directly corresponding to the selected chief complaint or chief complaints. Table 2 below provides a preferred list of mental health chief complaints for eliciting queries useful for assessing the mental health conditions in Table 1. The mental health assessment queries corresponding to each of the chief complaints in Table 2 preferably implement DSM criteria, for example the criteria of DSM-IV-TR or later revision.

TABLE 2

| Chief Complaint | Abbreviation |
|---|---|
| Behavior Problems | BP |
| Difficulty paying attention | DPA |
| Hyperactivity | HYPER |
| Irritability, anger, rages | ANG |
| Violent behavior | VIOL |
| Mood instability, “moody”, or crying spells, or “giggly” | MOOD |
| Anxiety or excessive worries | ANX |
| Sleep difficulties | SLEEP |
| Academic/School-related problems | SCHO |
| Depression or being withdrawn | DEP |
| Suicide thoughts or behavior | SUI |
| Eating difficulties | EAT |
| Obsessed, stubborn, rigid, “set in their ways”, “picky”, | STUBB |
| doing things “over and over” | |
| Hearing voices that others cannot hear | VOICE |
| Experienced traumatic event or victim of abuse | TRAU |
| Odd, strange or unusual behavior | ODD |
| Not talking or not communicating as expected for | TALK |
| his/her age | |
| Failed to develop age appropriate relationships | RELAT |
| Abuses nicotine, and/or alcohol, and/or drugs and/or | DRUG |
| pills, and/or inhalants | |

The assessment server 20 is alternatively configured to transmit instructions to the clinician client application 32 to provide the health assessment queries to a clinician end user, who may personally interview the patient or use other accepted methods for obtaining information for responding to the health assessment queries related to the patient. In such case, the health assessment queries are preferably provided to the clinician end user in the form of a mental status exam (MSE), permitting information to be obtained in a standard format accepted universally by most physicians, and as such a patient would not be required to interact with the patient client system 40 or other computing system. The clinician end user may query a patient in a conventional manner, for example during a live office visit, and input patient responses using the clinician client application 32 simultaneously with the patient response during an interview, or alternatively, at some period of time thereafter. The assessment server 20 is configured to receive health assessment query responses to the patient-related health assessment queries from the clinician end user using the clinician client system 30 in the manner indicated above with reference to the patient client system 40.

Based on the health assessment query responses elicited by the patient end user or clinician end user, the assessment server 20 transmits instructions to the clinician client application 32 to provide one or more of the health assessments along with the health assessment query responses to a clinician end user using the clinician client system 30. The clinician end user is preferably a health services professional such as a doctor responsible for care of the patient end user. As indicated above, the health assessments are preferably mental health assessments including condition assessments set forth in the DSM or ICD with their corresponding DSM or ICD codes, as set forth in Table 1. Moreover, condition assessments are provided with a corresponding Clinical Global Impression (CGI) score delivered on a scale from 1 to 7 where 1 is “not ill”, 2 is “very mildly ill”, 3 is ”mildly ill”, 4 is moderately ill”, 5 is “markedly ill”, 6 “is seriously ill” and 7 is “extremely ill”. Preferably, an affirmative condition assessment, defined as a condition assessment corresponding to a CGI of 2 or greater, is provided to the clinician client application 32 in response to receipt of affirmative responses from the patient end user to two or more of the symptom queries, indicating presence of those two or more symptoms. In the case where a symptom query provides a scaled selection having a severity range from 0-10, an affirmative response is preferably one in which the selected severity is 4 or greater. A non-affirmative condition assessment, defined as a condition assessment corresponding to a CGI of 1, is provided to the clinician client application 32 in response to receipt of affirmative responses of less than two of the symptom queries associated with the particular condition assessment, and may be provided with or without a CGI, or alternatively, may not be provided to the clinician end user.

Each relevant condition assessment and its associated DSM or ICD identification code transmitted to the clinician client system 30 is displayed through the clinician client application 32, with the health assessment query responses corresponding to the particular condition assessment displayed in proximity thereto. In such manner, the clinician end user may see how the health assessment query responses relate to a particular condition. Preferably, affirmative condition assessments are provided with a CGI.

In addition to generating a condition assessment, a traumatic brain injury assessment with a corresponding CGI is preferably also generated by the assessment server 20. An affirmative traumatic brain injury assessment indicating the presence of traumatic brain injury is generated by the assessment server 20 in response to receiving from the patient end user affirmative responses to one or more relevant symptom queries and one or more relevant risk factor queries. A suicide risk assessment is preferably also generated by the assessment server 20. An affirmative suicide risk assessment, indicating presence of a suicide risk, is generated with a corresponding CGI in response to receiving from the first end user affirmative responses to one or more relevant symptom queries, one or more relevant stressor queries, and one or more relevant risk factor queries. In another embodiment of the present invention, a homicide risk assessment may also be provided. Preferably, the condition assessment, the traumatic brain injury assessment, and the suicide risk assessment are provided in the form of a preliminary health assessment report for delivery by the assessment server 20 to the clinician end user through the clinician client application 32.

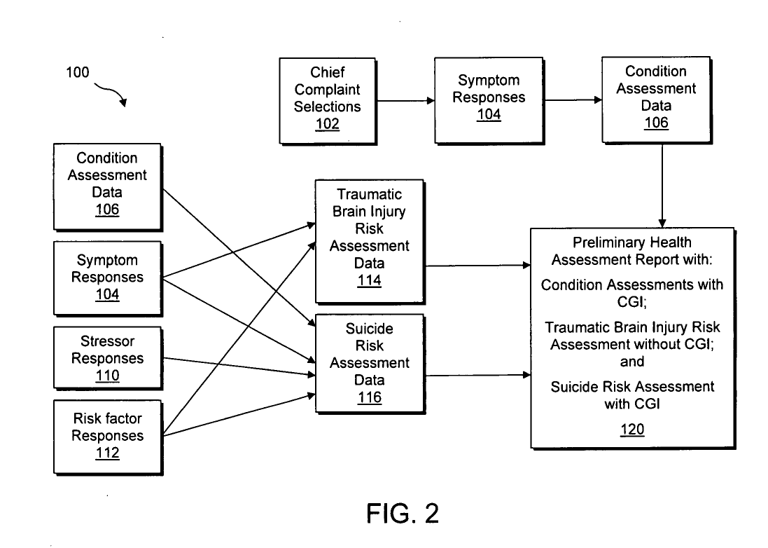

FIG. 2 sets forth a logic routine 100 according to a preferred embodiment of the present invention for generating a preliminary health assessment report 120 using the patient end user responses to queries generated by the assessment server 20. Preferably, the assessment server 20 follows the logic routine 100 through implementation of clinical algorithms, for example those clinical algorithms derived from the DSM and stored in the clinical algorithm database 14. Chief complaint selections 102 are used in the determination of appropriate symptom queries. User symptom responses 104 to the symptom queries are used to generate condition assessment data 106 with corresponding CGI or CGIs. As indicated above, symptom responses 104 to the symptom queries and risk factor responses 112 to risk factor queries are used in generating traumatic brain injury assessment data 114. Further, symptom responses 104 to symptom queries, risk factor responses 112 to risk factor queries, and stressor responses 110 to environmental stressor queries are used along with the condition assessment data 106 in generating suicide risk assessment data 116. The condition assessment data 106, traumatic brain injury assessment data 114 and suicide risk assessment data 116 are provided by the assessment server 20 through the clinician client application 32 to the clinician end user in the form of the preliminary health assessment report 120, which is logged in the clinician assessment report database 18.

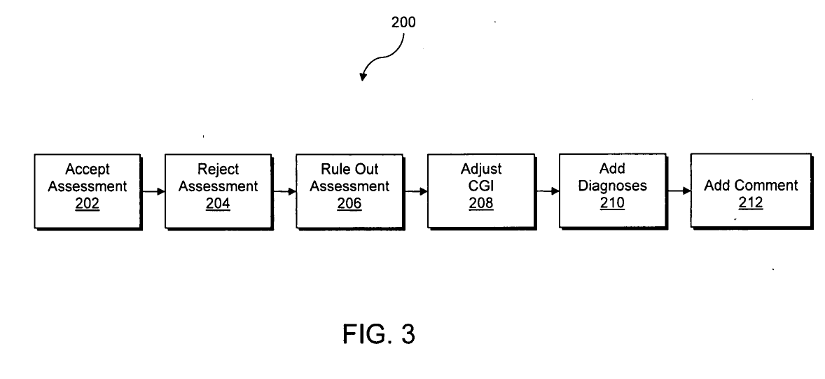

Referring to FIG. 3, a clinician diagnosis procedure 200 is set forth according to the preferred embodiment of the present invention. The clinician diagnosis procedure 200 is preferably implemented by a clinician end user in response to receipt of a health assessment or plurality of health assessments from the assessment server 20 through the clinician client application 32. The assessment server 20 is configured to receive from the clinician end user through the clinician client application 42 one of an acceptance (step 202), a rejection (step 204), and a ruling out (step 206) of each health assessment provided to the clinician end user. Preferably an acceptance, rejection or ruling out is received by the assessment server 20 from the clinician client application 32 in response to each affirmative condition assessment, affirmative traumatic brain injury assessment, and affirmative suicide risk assessment provided by the assessment server 20. This provides a way for the clinician end user to prepare a diagnosis by first considering the health assessment query responses and the health assessment or health assessments provided by the assessment server 20, as well as additional information received as a result of an in person client interview or physical test results. An acceptance of a particular health assessment may be considered to be a diagnosis if rendered by a health services professional authorized to make such a diagnosis. The assessment server 20 is further configured to receive from the clinician end user through the clinician client application 32 an adjusted CGI (step 208) for a particular accepted affirmative condition assessment, whereby the clinician end user may, pursuant to personal observations or other information, change the CGI indicated in the health assessment provided by the assessment server 20.

Preferably, the assessment server 20 is also configured to receive through the clinician client application 32 from an authorized health services professional an additional, user-generated health diagnosis (step 210) including a affirmative condition assessment, affirmative traumatic brain injury assessment, or affirmative suicide risk assessment with a corresponding CGI, such not having not been transmitted from the assessment server 20 to the clinician client application 32 in the form of an affirmative assessment. The user-generated health diagnosis is preferably selectable through the clinician client application 32 from the health assessments stored in the clinical algorithm database 14. Alternatively, the authorized health services professional may manually enter a new diagnosis not provided in the form of a health assessment in the clinical algorithm database 14. The clinician preferably provides the user-generated health diagnosis and the acceptance, rejection, or ruling out of each health assessment after personally interviewing the patient end user. Clinician comments are also preferably transmittable (step 212) through the clinician client application 32 to the assessment server 20.

The assessment server 20 generates a clinician assessment report preferably including the health assessment query responses and, for each health assessment transmitted, the acceptance, the rejection, or the ruling out of the health assessment, along with any user-generated health diagnosis and comments provided by the clinician end user. As such, the clinician assessment report includes both the proposed assessments set forth in the preliminary assessment report 120 discussed above along with input provided by the clinician end user. Preferably, the clinician assessment report includes applicable affirmative condition assessments, affirmative traumatic brain injury assessment, and/or affirmative suicide risk assessment with corresponding CGI and an indication of whether the assessment or assessments were accepted, rejected or ruled out by the clinician end user. The assessment server 20 logs the clinician assessment report in the clinician assessment report database 18. The clinician end user is preferably provided access to the report through the clinician client application 32. The assessment server 20 as well as the client query response database 16 and the clinician assessment report database 18 are preferably secure and Health Insurance Portability and Accountability Act (HIPAA) compliant. If desired, the patient end user may also be provided secure access to the patient's clinician assessment report through the patient client application 42.

The assessment server 20 is configured to transmit instructions to the patient client application 42 to provide the health assessment queries to the patient end user using the patient client system 40 during multiple intakes. During an initial patient end user intake, the patient preferably registers with the assessment server 20 and may be provided with or select a pass code to permit the assessment server 20 to identify the patient end user during a later intake. During follow-up intakes, the assessment server 20 may identify the patient end user and present follow-up health assessment queries relevant to that patient end user, preferably including health assessment queries corresponding to conditions assessed during a prior intake. The preliminary assessment report 120 preferably shows the patient end user's progress, including improvement or deterioration of conditions, by providing the clinician end user a comparison of current health query responses with prior health query responses entered during a prior intake.

As indicated above, the clinical algorithm database 14 preferably stores mental health assessment queries and corresponding mental health assessments in the form of rules based algorithms preferably governed at least in part by DSM criteria. In this manner, the assessment server 20 utilizes data in the clinical algorithm database 14 to generate health assessments, preferably in the form of the preliminary assessment report 120, based on health assessment query responses from a patient end user. Alternatively, the clinical algorithm database 14 may be updated, or another database provided, to permit use of data from the patient end users and clinician end users to implement case based algorithms for generating mental health assessments. In this manner, the assessment server 20 may generate mental health assessments for a given patient end user based on health assessment query responses given by one or more preceding patient end users in preceding intakes, or based on responses from one or more clinician end users, in the form of acceptances, rejections, ruling outs, added diagnoses, and modified CGIs transmitted in response to preceding intakes.

A preferred manner of implementing case based algorithms is one in which the assessment server 20 uses data regarding the plurality of patient end users stored in either or both of the client query response database 16 and the clinician assessment report database 18 to generate the case based algorithms for storage in the clinical algorithm database 14. As a first example, a plurality of patient end users may, as evidenced by two or more separate intakes, show improvement, deterioration or no change in severity of symptoms of a particular diagnosed condition as a result of a particular treatment. Case based algorithms may be generated by the assessment server 20 and stored in the clinical algorithm database, for generating health assessments for later patient end users based on the improvement, deterioration or no change in the severity of symptoms of previous patient end users. The case based algorithms are preferably in the form of modified rules based algorithms. These case based algorithms may alternatively be implemented for providing the clinician end user with proposed treatments for a diagnosed condition. As a second example of generating and implementing case based algorithms, one or more clinician end users may provide an acceptance, a rejection, a ruling out, added diagnoses, or a modified CGI in response to a particular health assessment generated by the assessment server 20 in response to health assessment query responses received by patient end users. Case based algorithms may be generated by the assessment server 20 for generating health assessments for later patient end users who provide similar health assessment query responses to the query responses provided by prior patient end users based on the acceptance, rejection, ruling out, added diagnoses, or modified CGI by the one or more clinician end users. The first and second examples show that the patient intake and assessment system 12 may function as an artificial intelligence system capable of learning from data stored in the client query response database 16 and the clinician assessment report database 18. Preferably, the assessment server 20 may pursuant to the desire of the clinician end user selectively implement either or both of rules based algorithms or case based algorithms in generating the health assessments.

The patient intake and assessment system 12, through its client query response database 16 and clinician assessment report database 18 provides an invaluable resource for tracking patient progress over multiple intakes, including the patient's reaction to a course of treatment, for example prescribed mediations. Accordingly, data mining for epidemiological research may be facilitated. Preferably, the assessment server 20 is configured to selectively de-identify patient data in compliance with HIPPA privacy policies to permit patient data to be accessed by those who wish to track the efficacy of a particular course of treatment. Moreover, permission is requested from a patient prior to using the patient's medical data for any purpose other than treating the patient. Clinician end users are preferably provided access to de-identified data of patient end users not under their care for the purpose of determining the efficacy of a particular treatment for other patient end users. For example, before prescribing a patient with a particular medication, the clinician end user is preferably provided access to the client query response database 16 and clinician assessment report database 18 to permit the clinician end user to assess the progress of other patients corresponding to one or more identical or similar health assessment query responses or health assessments as compared with the particular patient which the clinician end user is treating.

Aside from the direct benefits to health professionals, the patient intake and assessment system 12 provides researchers the ability to quantify vast patient and health professional clinical experience into one or more researchable databases to establish behavioral and psychiatric treatment response measures, behavioral measures, and treatment history analyses including but not limited to: treatment adverse event analyses, co-morbidity analyses, synergistic medication response analyses, genetic analyses, CGI improvement analyses, CGI severity analyses, symptom improvement analyses, psycho-social analyses, and congenital analyses. These measures, which to-date take vast amounts of human and financial capital to measure, may be extracted and analyzed with vastly less effort and financial cost from one or more of the above-indicated databases using de-identified patient data provided by the intake and assessment system 12 according to the preferred embodiment of the present invention.

During an initial patient end user intake, the assessment server 20 is preferably further configured to transmit instructions to the patient client application 42 to query a patient end user regarding whether the patient end user consents to be contacted regarding potential treatment options or clinical research projects. A patient end user may consent or not consent to be made aware of any new treatments or studies that may be made available for his or her condition or the condition of the person under his or her care. Preferably, an affirmative consent constitutes only a research pre-consent, such that a patient end user is not consenting to be a part of any particular clinical research study, rather the patient end user is only consenting to be made aware of any potential new studies. A patient end user is preferably informed of a potential new study via an Institutional Review Board (IRB) approved research consent form, and thereafter the patient end user may choose whether or not to participate in the study.

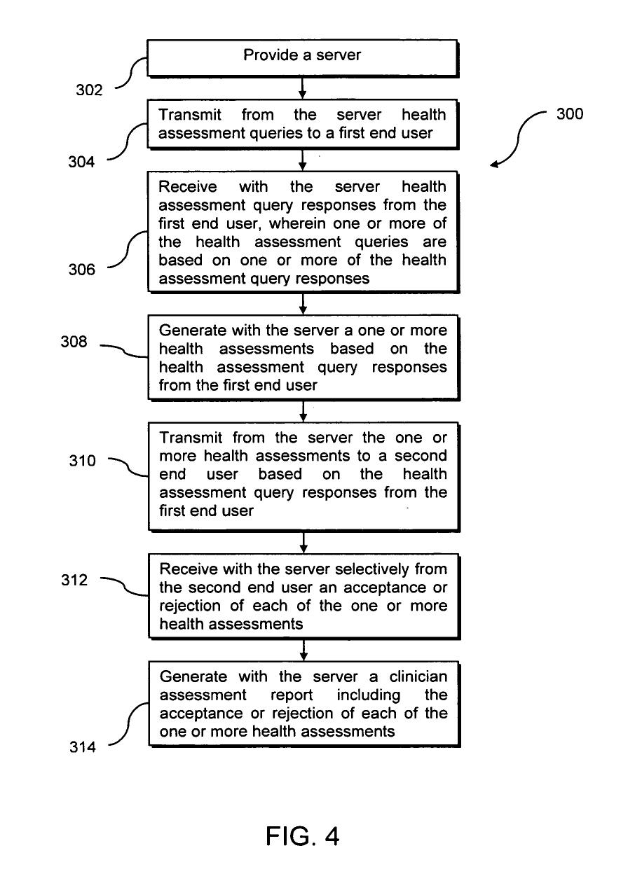

Referring to FIG. 4, a method 300 for patient assessment according to the preferred embodiment of the present invention is provided. The method 300 includes providing a server (step 302), and transmitting from the server health assessment queries to a first end user (step 304). The server receives health assessment query responses from the first end user (step 306) and generates one or more health assessments based on the health assessment query responses (step 308). The server transmits the one or more health assessments to a second end user (step 310) and receives selectively from the second end user an acceptance or rejection of each of the one or more health assessments (step 312). The server generates a clinician assessment report including the acceptance or rejection of each of the one or more health assessments (step 314). Preferably, one or more of the health assessment queries are transmitted from the server to the first end user based on one or more of the health assessment query responses from the first end user (step 306).

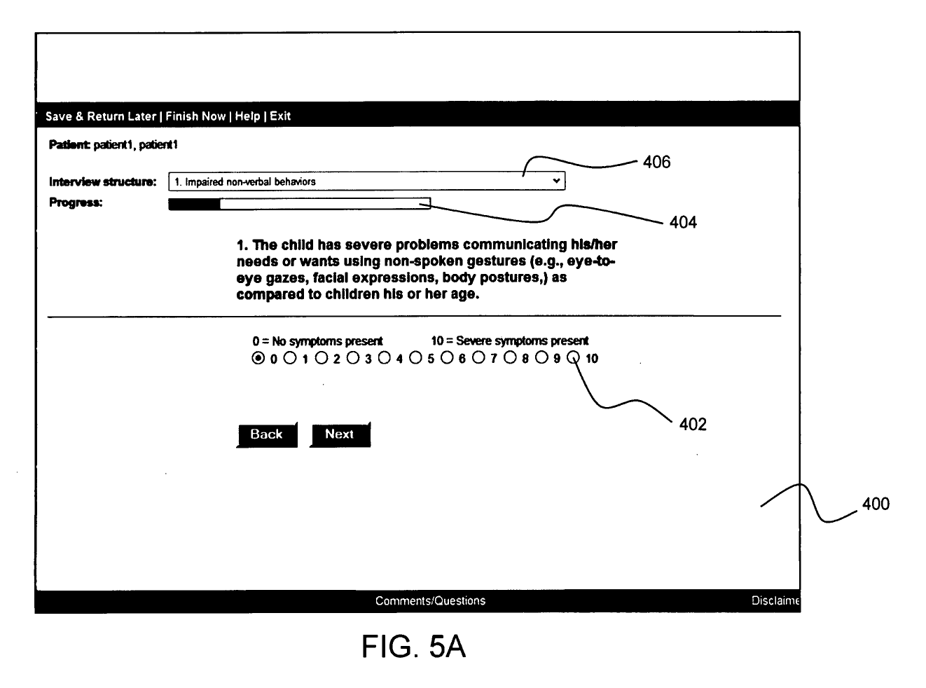

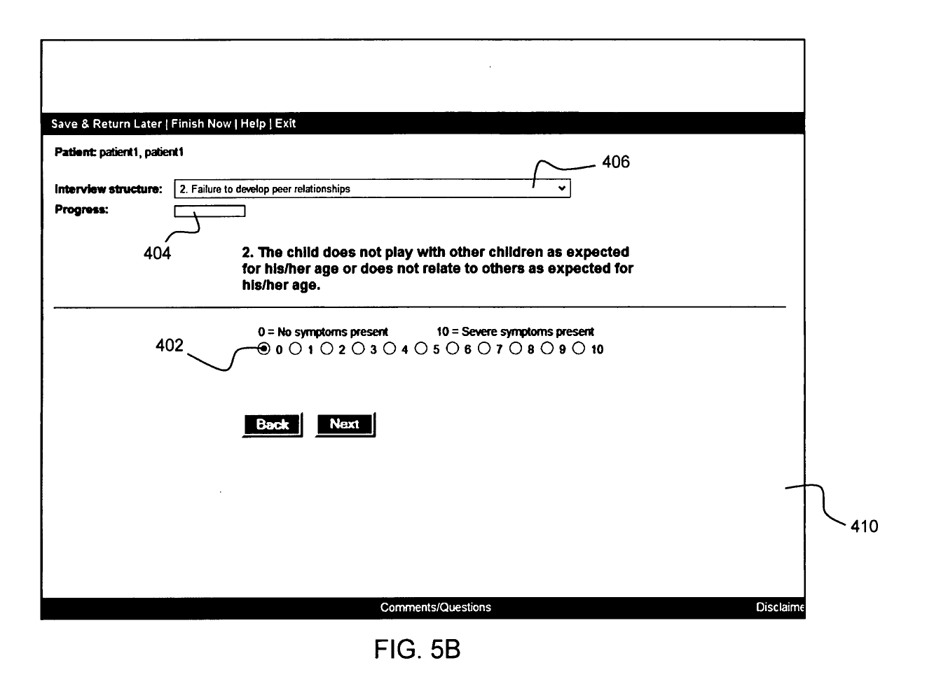

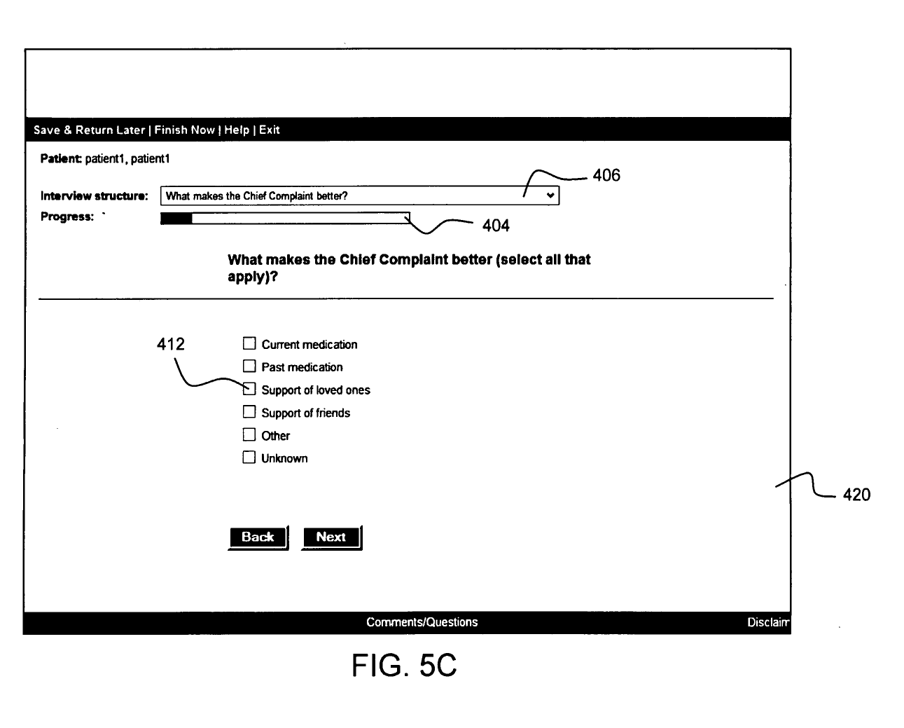

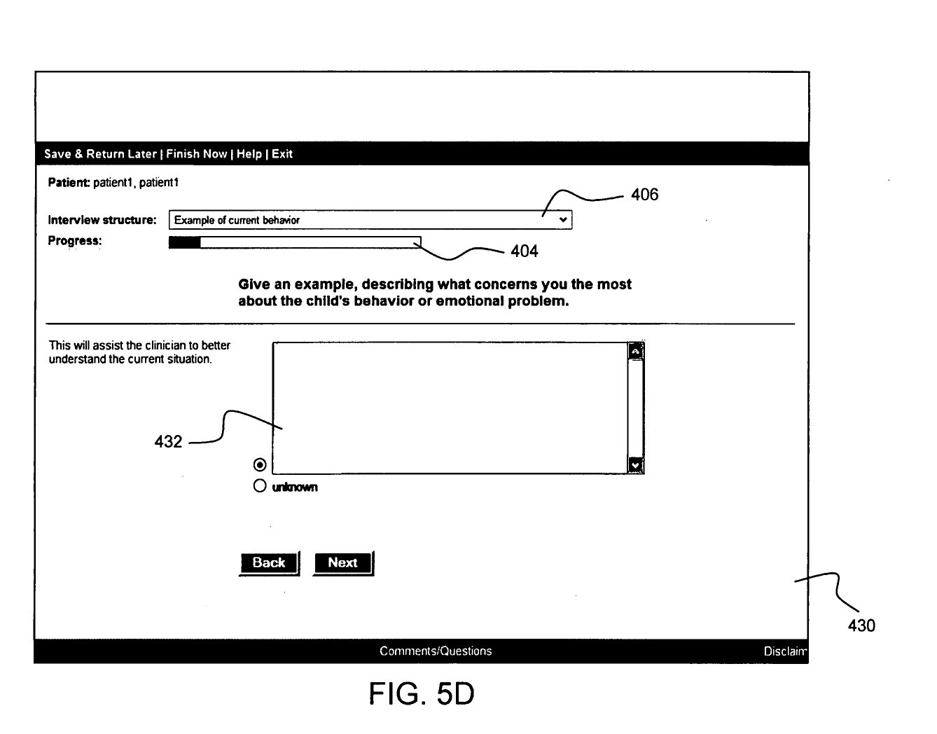

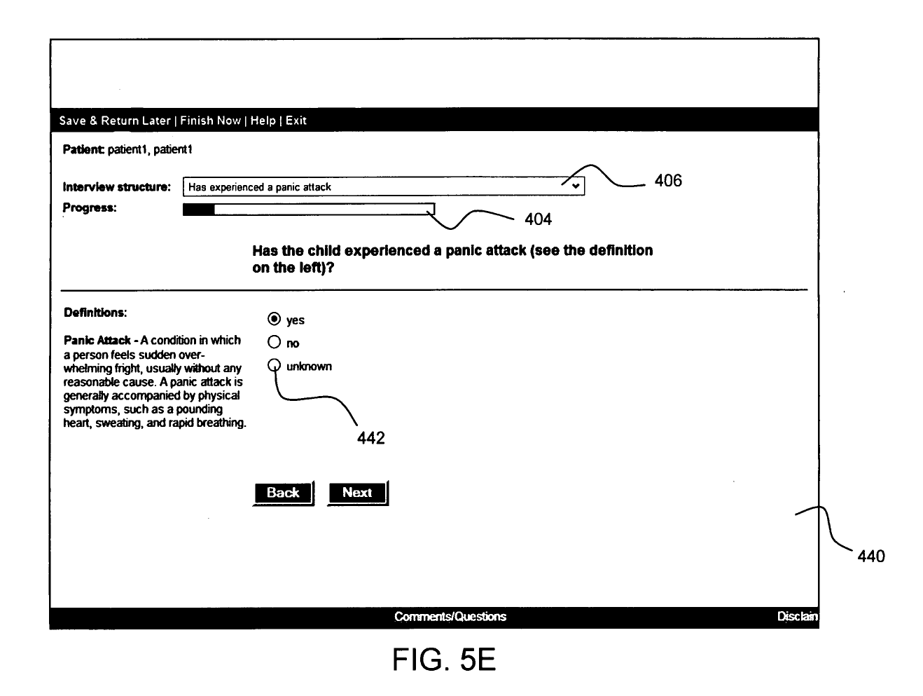

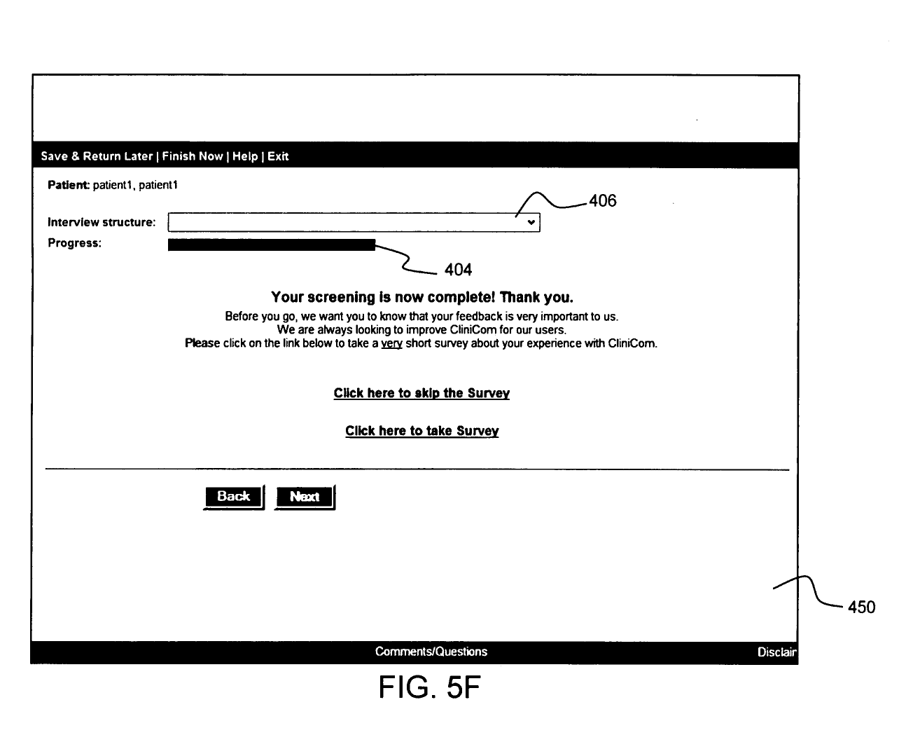

Referring to FIGS. 5A-5F, shown are sample screen captures from displays of the patient user interface 44 generated by the patient client application 42 implementing the method for patient intake and assessment according to the preferred embodiment of the present invention. A first screen capture 400 and a second screen capture 410 each show a scaled response selection 402 permitting a patient end user to offer an indication of to what degree or intensity a symptom is present. The symptom query is positioned above the scaled response selection as shown. A third screen capture 420 shows a multiple choice selection field 412, a fourth screen capture 430 shows a free form text entry response field 432, and a fifth screen capture 440 shows a yes-no-unknown text entry response field 442. A sixth screen capture 450 displays exit instructions indicating that the patient end user portion of the intake and assessment has been completed. Each of the screen captures show a progress meter 404 indicating how far the patient end user has progressed through the intake and assessment. An interview structure bar 406 classifies the query or particular set of queries which the patient end user is presented with.

Table 3 below shows an example excerpt of a preliminary health assessment report 120 for delivery to the clinician end user through the clinician client application 32, showing patient end user symptom query responses. In the example excerpt shown, the displayed patient end user responses are provided in the form of a severity scale selection of the type indicated above on a scale from 0-10. As also indicated above, other responses from the patient end user related in the preliminary health assessment report 120 may include multiple choice, true-false-unknown, yes-no-unknown, free form text entry type queries or any suitable type query responses. Query responses are grouped with a corresponding condition, designated by a DSM code, which is assessed based on the respective group of query responses. In the example case excerpted below, shown are condition assessment descriptions for “Manic Episode” and “Overanxious/Generalized Anxiety Disorder”, with the queries used to assess these conditions conveniently positioned under the condition assessment descriptions.

As indicated above, a selection by a patient end user of a chief complaint in Table 2, may elicit queries pertaining to one or more of the condition assessments in Table 1. For example, a user selection of any of the chief complaints BP, ANG, VIOL, MOOD, SLEEP, DEP, SUI, LEGAL in Table 2 may elicit queries for assessing “296.00 Manic Episode”, among other conditions. Preferably, chief complaints should elicit queries corresponding to more than one of the condition assessments listed in Table 1. For example, selecting only DPA “Difficulty paying attention” from Table 2 as a chief complaint may elicit queries corresponding to the assessment of “314.00 ADHD, Inattentive type”, “315.90 Learning Disorder”, “307.40 Sleep Disorder”, and “307.90 Communication Disorder”. One skilled in the art will recognize that any suitable selection of queries may be implemented which is consistent with the criteria set forth in an accepted version of the DSM.

At the bottom of Table 3, affirmative condition assessments “300.02 Generalized Anxiety Disorder” and “307.40 Sleep Disorders” as generated by the assessment server 20 are clearly listed, indicating the presence of these conditions based on the patient end user query responses. The clinician end user and may selectively accept, reject or rule out each affirmative condition assessment after which a finalized clinician assessment report may be generated.

TABLE 3

| | Severity |
|---|---|
| Symptoms - 296.00 Manic Episode | |
| 1. Inflated self-esteem, elation or grandiosity during manic episode | 3 |
| 2. Severe irritability during manic episode | 3 |
| 3. Decreased need for sleep | 6 |
| 4. More talkative than usual | 0 |
| 5. Flight of ideas (jumps from one topic to another) | 0 |
| 6. Distractibility | 0 |
| 7. Increase in goal-directed activity (several unfinished projects) | 0 |
| 8. Excessive pleasurable activities with high risk of painful consequences | 0 |
| . . . | |
| Symptoms - 300.02 Overanxious/Generalized Anxiety Disorder | |
| 1. Excessive worries, restlessness or feeling on edge for more than six months | 6 |
| 2. Being easily fatigued | 4 |
| 3. Difficulty concentrating or mind going blank | 4 |
| 4. Irritability | 4 |
| 5. Muscle tension | 4 |
| 6. Sleep Disturbance | 4 |
| 7. Difficulty controlling worries | 5 |
| . . . | |
| Symptoms - 307.40 Sleep Disorder | |
| 1. Difficulty falling asleep | 5 |
| 2. Difficulty maintaining sleep | 5 |
| 3. Fatigue | 5 |
| 4. Excessive sleep during daytime | 5 |
| 5. Sudden urges to sleep during daytime | 3 |
| 5. Snoring for at least one month | 3 |
| 6. Stops breathing while asleep for at least one month | 0 |
| 7. Sleep walking | 0 |
| 8. Sleep talking | 0 |
| 10. Nightmares | 0 |
| . . . | |
| Assessments To Be Reviewed By Clinician: | |
| . . . | |
| 300.02 Generalized Anxiety Disorder | CGI 5 |
| . . . | |
| 307.40 Sleep Disorders | CGI 5 |
| . . . | |

Table 4 below shows an example excerpt from a clinician assessment report, which is the finalized version of the preliminary health assessment report 120 set forth in part in Table 3, and further including the clinician end user's acceptances, rejections, ruling-outs, comments and added diagnosis.

TABLE 4
Assessments Reviewed By Clinician

| | | |
|---|---|---|
| 295.40 Schizophreniform Disorder | Accepted by Clinician | CGI 5 |
| 300.02 Generalized Anxiety Disorder | Rejected by Clinician | CGI 5 |
| 300.21 Panic Disorder with Agoraphobia | Accepted by Clinician | CGI 5 |
| 300.4 Dysthymic Disorder | Accepted by Clinician | CGI 6 |
| 307.40 Sleep Disorders | Accepted by Clinician | CGI 5 |
| 309.81 Posttraumatic Stress Disorder | Rejected By Clinician | CGI 4 |
| Consider Traumatic Brain Injury | Rule Out | Need to obtain more data |
| Suicidality | Accepted By Clinician | CGI 6 |

Diagnoses Added By Clinician

| | |
|---|---|
| 313.01 Oppositional Defiant Disorder | CGI 4 |
| 296.89 Bipolar II Disorder | CGI 5 |

Comments

none

| | |
|---|---|
| Clinician Signature: Dr. John Doe | Date: Jan. 20, 2008 |

In the example excerpt shown in Table 4, the clinician end user provided five assessment acceptances, two assessment rejections, and one assessment ruling out. Further, two additional diagnoses were provided which were not initially provided as assessments by the assessment server 20 through the clinician client application 32. Alternatively, the clinician assessment report may be exported as a narrative report in continuous paragraph form, rather than an itemized list as shown in Table 4, suitable for integration into referral letters, reports, or other documents benefiting from such continuous description.

Alternatively, the assessment server 20 may be configured to automatically export data from the clinician assessment report database 18, including any data received from a clinician end user or patient end user, to populate an electronic medical record system (EMR system). Data corresponding to one or more patients may be extracted item by item from the clinician assessment report database 18 to populate corresponding fields within an EMR system.

The present invention further provides a client application program product having a computer readable medium with instructions operable to enable a client computer to perform a procedure. This procedure includes identifying a first end user and a second end user, and receiving instructions from a server to provide health assessment queries to the first end user. This procedure further includes transmitting health assessment query responses from the first end user to the server, and receiving instructions from the server to provide a health assessment to a second end user based on the health assessment query responses from the first end user. The instructions enable a client computer to transmit from the second end user to the server selectively an acceptance of the health assessment, a rejection of the health assessment, and a user-generated health diagnosis. The client computer is further enabled to receive instructions from the server to provide to the second end user a clinician assessment report including one or more of the acceptance of the health assessment, the rejection of the health assessment, and the user-generated health diagnosis.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A patient intake and assessment system for communication with end users in a computer network, the system comprising:
a clinical algorithm database configured to store a plurality of health assessment queries and a plurality of health assessments;
a clinician assessment report database configured to store a plurality of clinician assessment reports;
at least one server in communication with the clinical algorithm database and the clinician assessment report database, the at least one server configured to:
transmit instructions to a first client application to provide the plurality of health assessment queries to a first end user;
receive a plurality of health assessment query responses from the first end user;
transmit instructions to a second client application to provide the plurality of health assessment query responses from the first end user to a second end user and to provide at least one of the plurality of health assessments to the second end user based on the plurality of health assessment query responses from the first end user;
receive from the second end user selectively through the second client application an acceptance of the at least one of the plurality of health assessments, a rejection of the at least one of the plurality of health assessments, and a user-generated health diagnosis; and
generate the clinician assessment report comprising the health assessment query responses and at least one of the acceptance of the at least one of the plurality of health assessments, the rejection of the at least one of the plurality of health assessments, and the user-generated health diagnosis, and log the clinician assessment report in the clinician assessment report database.

2. The system of claim 1, further comprising a client query response database in communication with the at least one server, the client query response database configured for logging the plurality of health assessment query responses from the first end user, wherein the at least one server is configured to transmit instructions to the first client application to provide at least one of the plurality of health assessment queries based on at least one of the plurality of health assessment query responses from the first end user logged in the client query response database.

3. The system of claim 2, wherein the client query response database, the clinical algorithm database, and the clinician assessment report database are formed as a single integrated database.

4. The system of claim 1, wherein the at least one server is further configured to:
receive from the second end user selectively through the second client application a ruling out of the at least one of the plurality of health assessments; and
generate the clinician assessment report comprising at least one of the acceptance of the at least one of the plurality of health assessments, the rejection of the at least one of the plurality of health assessments, the user-generated health diagnosis, and the ruling out of the at least one of the plurality of health assessments, and log the clinician assessment report in the clinician assessment report database.

5. The system of claim 1, wherein the at least one server is configured to transmit instructions to the second client application to provide the at least one of the plurality of health assessments with a corresponding identification code comprising at least one of a DSM code and an ICD code.

6. The system of claim 1, wherein the at least one server is configured to transmit instructions to the second client application to provide the at least one of the plurality of health assessments comprising a CGI.

7. The system of claim 6, wherein the at least one server is configured to receive from the second end user selectively through the second client application an adjusted CGI for the at least one of the plurality of health assessments.

8. The system of claim 1, wherein the at least one server is configured to transmit instructions to the second client application to provide the at least one of the plurality of health assessments based on receipt of affirmative responses from the first end user to at least two of the plurality of health assessment queries, wherein the affirmative responses comprise an indication of whether a symptom is present.

9. The system of claim 1, wherein the at least one server is configured to transmit instructions to the second client application to provide the at least one of the plurality of health assessments based on receipt of affirmative responses to at least two of the plurality of health assessment queries from the first end user, wherein at least one of the at least two of the plurality of health assessment queries provides a scaled response selection, and wherein the affirmative responses comprise an indication that a symptom is present at a predetermined severity level of the scaled response selection and an indication that the symptom is present for a predetermined period of time.

10. The system of claim 1, wherein the at least one server is further configured to:
transmit instructions to the first client application to provide the plurality of health assessment queries, wherein the plurality of health assessment queries comprise symptom queries with scaled response selections, and duration of symptom queries; and
transmit instructions to the second client application to provide the at least one of the plurality of health assessments based on receipt of affirmative responses to a predetermined number of the symptom queries and the duration of symptom queries from the first end user, wherein each of the affirmative responses comprises an indication that a symptom is present at a predetermined severity level of the scaled response selection and an indication that the symptom is present for a predetermined period of time.

11. The system of claim 1, wherein the at least one server is configured to:
transmit the instructions to the first client application which comprises a web browser; and
transmit the instructions to the second client application which comprises a web browser;
wherein the first client application and the second client application are at least one of a same client application installed on a same client system, a same client application installed on different client systems, different client applications installed on a same client system, and different client applications installed on different client systems.

12. The system of claim 1, wherein the at least one server is configured to store the plurality of health assessments, wherein the plurality of health assessments comprise a plurality of mental health assessments.

13. The system of claim 1, wherein the at least one server is further configured to:
transmit instructions to the first client application to provide the plurality of health assessment queries to the first end user during at least two intakes separated by a predetermined period of time;
transmit instructions to at least one of the first client application and a third client application to provide the plurality of health assessment queries to a third end user;
receive a plurality of health assessment query responses from the third end user; and
transmit instructions to a fourth client application to provide the plurality of health assessment query responses from the third end user to a fourth end user and to provide at least one of the plurality of health assessments to the fourth end user based on the plurality of health assessment query responses from the third end user and based on the plurality of health assessment query responses from the first end user.

14. The system of claim 1, wherein the at least one server is further configured to:
transmit instructions to at least one of the first client application and a third client application to provide the plurality of health assessment queries to a third end user;
receive a plurality of health assessment query responses from the third end user; and
transmit instructions to at least one of the second client application and a fourth client application to provide the plurality of health assessment query responses from the third end user to at least one of the second end user and a fourth end user and to provide at least one of the plurality of health assessments to the at least one of the second end user and the fourth end user based on at least one of the second end user's acceptance of the at least one of the plurality of health assessments of the first end user, the second end user's rejection of the at least one of the plurality of health assessments of the first end user, and the second end user's user-generated health diagnosis of the first end user.

15. A method for patient assessment comprising:
providing at least one server;
transmitting from the at least one server a plurality of health assessment queries to a first end user;
receiving with the at least one server a plurality of health assessment query responses from the first end user;
generating with the at least one server at least one health assessment based on the plurality of health assessment query responses from the first end user;
transmitting from the at least one server the at least one health assessment to a second end user;
receiving with the at least one server selectively from the second end user an acceptance of the at least one health assessment and a rejection of the at least one health assessment; and
generating with the at least one server a clinician assessment report comprising at least one of the acceptance of the at least one health assessment and the rejection of the at least one health assessment;
wherein at least one of the plurality of health assessment queries is transmitted from the at least one server to the first end user based on at least one of the plurality of health assessment query responses from the first end user.

16. The method of claim 15, wherein:
transmitting the plurality of health assessment queries comprises transmitting chief complaints for selection by the first end user, wherein each of the chief complaints corresponds with predetermined symptom queries;
receiving the plurality of health assessment query responses comprises receiving a selection of at least one of the chief complaints;
transmitting the plurality of health assessment queries further comprises transmitting the symptom queries corresponding with the selected at least one of the chief complaints;
receiving the plurality of health assessment query responses further comprises receiving scaled responses to the symptom queries; and
generating the at least one health assessment comprises generating at least one affirmative condition assessment in response to receiving affirmative responses to at least two of the symptom queries.

17. The method of claim 16, wherein transmitting at least one of the unique symptom queries comprises submitting at least one query comprising DSM criteria.

18. The method of claim 16, wherein transmitting the at least one health assessment comprises transmitting at least one of a DSM and ICD condition assessment and transmitting at least one of a DSM code and an ICD code corresponding with the at least one of the DSM and ICD condition assessment.

19. The method of claim 18, wherein transmitting the at least one health assessment comprises transmitting a CGI corresponding to the at least one health assessment.

20. The method of claim 15, wherein transmitting the plurality of health assessment queries comprises transmitting a plurality of symptom queries, a plurality of stressor queries and a plurality of risk factor queries.

21. The method of claim 20, wherein:
generating the at least one health assessment comprises:
generating at least one condition assessment, wherein an affirmative condition assessment is generated in response to receiving from the first end user affirmative responses to at least two of the symptom queries;
generating a traumatic brain injury assessment, wherein an affirmative traumatic brain injury assessment is generated in response to receiving from the first end user affirmative responses to at least one of the symptom queries and at least one of the risk factor queries; and
generating a suicide risk assessment, wherein an affirmative suicide risk assessment is generated in response to receiving from the first end user affirmative responses to at least one of the symptom queries, at least one of the stressor queries, and at least one of the risk factor queries; and
generating the clinician assessment report comprises generating a report comprising the at least one condition assessment, the traumatic brain injury assessment, and the suicide risk assessment.

22. The method of claim 15, further comprising:
receiving with the at least one server selectively from the second end user a user-generated health diagnosis; and
generating with the at least one server the clinician assessment report comprising at least one of the acceptance of the at least one health assessment, the rejection of the at least one health assessment, and the user-generated health diagnosis.

23. The method of claim 15, further comprising:
transmitting from the at least one server the plurality of health assessment queries to a plurality of patient end users during at least a first intake and a second intake of each of the plurality of patient end users, wherein the plurality of users are undergoing at least one course of treatment between the first intake and the second intake;
receiving with the at least one server the plurality of health assessment query responses from the plurality of patient end users from the at least the first intake and the second intake;
comparing the plurality of health assessment query responses from the plurality of patient end users during the first intake with the plurality of health assessment query responses from the plurality of patient end users respectively during the second intake; and
transmitting the comparison of the plurality of health assessment query responses to the second end user, whereby the second end user may assess the efficacy of the at least one course of treatment of the plurality of patient end users for the purpose of prescribing another course of treatment to the first end user.

24. The method of claim 15, further comprising:
transmitting from the at least one server the plurality of health assessment queries to a plurality of patient end users including the first end user during at least a first intake and a second intake of each of the plurality of patient end users;
receiving with the at least one server the plurality of health assessment query responses from the plurality of patient end users from the at least the first intake and the second intake;
generating with the at least one server the at least one health assessment as a plurality of health assessments for the plurality of patient end users based on the plurality of health assessment query responses from the plurality of patient end users;
transmitting from the at least one server the plurality of health assessments to the second end user;
receiving with the at least one server selectively from the second end user acceptances of the plurality of health assessments and rejections of the plurality of health assessments;
generating with the at least one server a clinician assessment report comprising at least one of the acceptances of the plurality of health assessments and the rejections of the plurality of health assessments; and
comparing with the at least one server the plurality of health assessment query responses from the plurality of patient end users during the at least the first intake with the plurality of health assessment query responses from the plurality of patient end users respectively during the at least the second intake to determine a treatment efficacy.

25. A client application program product comprising a computer readable medium comprising instructions, the instructions being operable to enable at least one client computer to perform a procedure comprising:
identifying a first end user;
identifying a second end user;
receiving instructions from at least one server to provide a plurality of health assessment queries to the first end user;
transmitting a plurality of health assessment query responses from the first end user to the at least one server;
receiving instructions from at least one server to provide at least one health assessment to a second end user based on the plurality of health assessment query responses from the first end user;
transmitting from the second end user selectively an acceptance of the at least one health assessment, a rejection of the at least one health assessment, and a user-generated health diagnosis to the at least one server; and
receiving instructions from at least one server to provide a clinician assessment report comprising at least one of the acceptance of the at least one health assessment, the rejection of the at least one of health assessment, and the user-generated health diagnosis to the second end user.
